(19) United States
(12) Patent Application Publication
(10) Pub. No.: US 2021/0137292 A1
(43) Pub. Date: May 13, 2021

(54) Automated Cup Lid Assembly

(71) Applicant: Theron Hageman, Jay Em, WY (US)

(72) Inventor: Theron Hageman, Jay Em, WY (US)

(21) Appl. No.: 16/679,988

(22) Filed: Nov. 11, 2019

(51) Int. Cl. A47G 19/22; B65D 53/02; B65D 51/24

(52) U.S. Cl. CPC A47G 19/2272; B65D 51/24; B65D 53/02

(57) ABSTRACT

An automated cup lid assembly includes a lid that is positionable on a beverage cup for closing the beverage cup. The lid has a drinking aperture extending therethrough for drinking. A closure is slidably coupled to the lid and the closure is positionable between an open position and a closed position. The closure covers the drinking aperture when the closure is in the closed position and the drinking aperture is exposed when the closure is in the open position. A motion unit is integrated into the lid and the motion unit is in mechanical communication with the closure. The motion unit urges the closure into the open position when the motion unit senses that the beverage cup is near a user's mouth. Additionally, the motion unit urges the closure into the closed position when the motion unit no longer senses that the beverage cup is near the user's mouth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to automated lid devices and more particularly pertains to a new automated lid device for automatically opening and closing a beverage cup.

### (2) Description of Related Art Including Information Disclosed Under 37 CFR 1.97 and 1.98

The prior art relates to automated lid devices.

### BRIEF SUMMARY OF THE INVENTION

An embodiment of the disclosure meets the needs presented above by generally comprising a lid that is positionable on a beverage cup for closing the beverage cup. The lid has a drinking aperture extending therethrough for drinking. A closure is slidably coupled to the lid and the closure is positionable between an open position and a closed position. The closure covers the drinking aperture when the closure is in the closed position and the drinking aperture is exposed when the closure is in the open position. A motion unit is integrated into the lid and the motion unit is in mechanical communication with the closure. The motion unit urges the closure into the open position when the motion unit senses that the beverage cup is near a user's mouth. Additionally, the motion unit urges the closure into the closed position when the motion unit no longer senses that the beverage cup is near the user's mouth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a automated cup lid assembly according to an embodiment of the disclosure.

FIG. 2 is a bottom phantom view of an embodiment of the disclosure.

FIG. 3 is a cross sectional view taken along line 3-3 of FIG. 2 of an embodiment of the disclosure showing a closure in a closed position.

FIG. 4 is a cross sectional view taken along line 3-3 of FIG. 2 of an embodiment of the disclosure showing a closure in an open position.

FIG. 5 is a perspective in-use view of an embodiment of the disclosure.

FIG. 6 is a schematic view of an embodiment of the disclosure.

### DETAILED DESCRIPTION OF THE INVENTION

With reference now to the drawings, and in particular to FIGS. 1 through 6 thereof, a new automated lid device embodying the principles and concepts of an embodiment of the disclosure and generally designated by the reference numeral 10 will be described.

As best illustrated in FIGS. 1 through 6, the automated cup lid assembly 10 generally comprises a lid 12 that is positionable on a beverage cup 14 for closing the beverage cup 14. The lid 12 has a top surface 16, a bottom surface 18 and an outer surface 20 extending therebetween. The lid 12 has a lip 22 extending upwardly from the top surface 16, and the lip 22 is aligned with and is coextensive with the outer surface 20. The outer surface 20 has a first portion 24 that is recessed with respect to a second portion 26. The first portion 24 is insertable into the beverage cup 14 having a threshold 28 between the first portion 24 and the second portion 26 resting on the beverage cup 14.

The lid 12 has a drinking aperture 30 extending therethrough to pass a liquid therethrough for drinking. The drinking aperture 30 extends through the top surface 16 and the bottom surface 18. A gasket 32 is coupled around the first portion 24 of the outer surface 20 of the lid 12. The gasket 32 forms a fluid impermeable seal with the beverage cup 14 when the lid 12 is positioned on the beverage cup 14. In this way the gasket 32 can inhibit liquid from leaking out of the beverage cup 14.

A closure 34 is provided and the closure 34 is slidably coupled to the lid 12. The closure 34 is positionable between an open position and a closed position. The closure 34 covers the drinking aperture 30 when the closure 34 is in the closed position. Additionally, the drinking aperture 30 is exposed when the closure 34 is in the open position. The closure 34 may include, but not be limited to, a panel that is slidably integrated into the lid 12 or a tab that is movably positioned on the lid 12.

A motion unit 36 is integrated into the lid 12, the motion unit 36 is in mechanical communication with the closure 34 and the motion unit 36 senses motion. The motion unit 36 urges the closure 34 into the open position when the motion unit 36 senses that the beverage cup 14 is within a trigger distance of the a user's mouth. In this way the motion unit 36 facilitates the user to drink from the beverage cup 14 without manually opening the closure 34. The motion unit 36 urges the closure 34 into the closed position when the motion unit 36 no longer senses that the beverage cup 14 is within the trigger distance of the user's mouth. In this way the user can drink from the beverage cup 14 with one hand, thereby facilitating the user to drive a vehicle, operate machinery or perform any other task while drinking from the beverage cup 14.

The motion unit 36 comprises a control circuit 38 that is integrated into the lid 12. The control circuit 38 receives an open input and a close input. An actuator 40 is integrated into the lid 12 and the actuator 40 is in mechanical communication with the closure 34. Additionally, the actuator 40 is electrically coupled to the control circuit 38. The actuator 40 is turned on to urge the closure 34 into the open position when the control circuit 38 receives the open input. The actuator 40 is turned on to urge the closure 34 into the closed position when the control circuit 38 receives the close input. The actuator 40 may comprise an electric motor, a linear actuator or any other type of electro-mechanical actuator that can move in two directions.

A motion sensor 42 is coupled to the lid 12 and the motion sensor 42 is electrically coupled to the control circuit 38. The motion sensor 42 senses motion within the trigger distance of the lid 12. Moreover, the control circuit 38 receives the open input when the motion sensor 42 senses motion within the trigger distance. The control circuit 38 receives the close input when the motion sensor 42 does not sense motion within the trigger distance. The motion sensor 42 may comprise an electronic motion sensor, such as an infra-red motion sensor or the like. Additionally, the trigger distance may be a distance ranging between approximately 6.0 inches and 12.0 inches.

A transceiver 44 is integrated into the lid 12 and the transceiver 44 is electrically coupled to the control circuit 38. Additionally, the transceiver 44 is in wireless communication with a remote control 46 for remotely controlling the actuator 40. The transceiver 44 may be a radio frequency transceiver 44 or the like. The remote control 46 may comprise a personal electronic device, such as a smart phone, a fit bit or any other device that has wireless communication capabilities. A power supply 48 is coupled to the lid 12, the power supply 48 is electrically coupled to the control circuit 38 and the power supply 48 comprises at least one battery 50. The power supply 48 includes a charge port 52 that is recessed into the outer surface 20 of the lid 12. The charge port 52 is electrically coupled to the at least one battery 50 and the charge port 52 can be electrically coupled to a charger for charging the at least one battery 50.

In use, the lid 12 is positioned on the beverage cup 14 when the beverage cup 14 is filled with a beverage. The motion unit 36 urges the closure 34 into the open position when the user lifts the beverage cup 14 toward their mouth for drinking. Thus, the user can drink the beverage through the drinking aperture 30. The motion unit 36 urges the closure 34 into the closed position when the user lowers the beverage cup 14 away from their mouth. In this way drinking aperture 30 is closed when the beverage cup 14 is set down. Thus, a driver of a vehicle or an operator of machinery can drink the beverage from the beverage cup 14 without having to manually open and close the drinking aperture 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated cup lid assembly being configured to automatically open and close for drinking a beverage from a cup, said assembly comprising:
a lid being positionable on a beverage cup for closing the beverage cup, said lid having a drinking aperture extending therethrough wherein said drinking aperture is configured to pass a liquid therethrough for drinking;
a closure being slidably coupled to said lid, said closure being positionable between an open position and a closed position, said closure covering said drinking aperture when said closure is in said closed position, said drinking aperture being exposed when said closure is in said open position; and
a motion unit being integrated into said lid, said motion unit being in mechanical communication with said closure, said motion unit sensing motion, said motion unit urging said closure into said open position when said motion unit senses that the beverage cup is within a trigger distance of the a user's mouth wherein said motion unit is configured to facilitate the user to drink from the beverage cup without manually opening said closure, said motion unit urging said closure into said closed position when said motion unit no longer senses that the beverage cup is within the trigger distance of the user's mouth.

2. The assembly according to claim 1, wherein said lid has a top surface, a bottom surface and an outer surface extending therebetween, said lid having a lip extending upwardly from said top surface, said lip being aligned with and being coextensive with said outer surface, said outer surface having a first portion being recessed with respect to a second portion, said first portion being insertable into the beverage cup having a threshold between said first portion and said second portion resting on the beverage cup, said drinking aperture extending through said top surface and said bottom surface.

3. The assembly according to claim 2, further comprising a gasket being coupled around said first portion of said outer surface of said lid, said gasket forming a fluid impermeable seal with the beverage cup when said lid is positioned on the beverage cup wherein said gasket is configured to inhibit liquid from leaking out of the beverage cup.

4. The assembly according to claim 1, wherein said motion unit comprises a control circuit being integrated into said lid, said control circuit receiving an open input and a close input.

5. The assembly according to claim 4, wherein said motion unit includes an actuator being integrated into said lid, said actuator being in mechanical communication with said closure, said actuator being electrically coupled to said control circuit, said actuator being turned on to urge said closure into said open position when said control circuit receives said open input, said actuator being turned on to urge said closure into said closed position when said control circuit receives said close input.

6. The assembly according to claim 5, wherein said motion unit includes a motion sensor being coupled to said lid, said motion sensor being electrically coupled to said control circuit, said motion sensor sensing motion within said trigger distance of said lid, said control circuit receiving said open input when said motion sensor senses motion within said trigger distance, said control circuit receiving said close input when said motion sensor does not sense motion within said trigger distance.

7. The assembly according to claim 6, wherein said motion unit includes a transceiver being integrated into said lid, said transceiver being electrically coupled to said control circuit, said transceiver being in wireless communication with a remote control for remotely controlling said actuator.

8. The assembly according to claim 7, wherein said motion unit includes a power supply being removably coupled to said lid, said power supply being electrically coupled to said control circuit, said power supply comprising at least one battery.

9. An automated cup lid assembly being configured to automatically open and close for drinking a beverage from a cup, said assembly comprising:
a lid being positionable on a beverage cup for closing the beverage cup, said lid having a top surface, a bottom surface and an outer surface extending therebetween, said lid having a lip extending upwardly from said top surface, said lip being aligned with and being coextensive with said outer surface, said outer surface having a first portion being recessed with respect to a second portion, said first portion being insertable into the beverage cup having a threshold between said first portion and said second portion resting on the beverage cup, said lid having a drinking aperture extending therethrough wherein said drinking aperture is configured to pass a liquid therethrough for drinking, said drinking aperture extending through said top surface and said bottom surface;
a gasket being coupled around said first portion of said outer surface of said lid, said gasket forming a fluid impermeable seal with the beverage cup when said lid is positioned on the beverage cup wherein said gasket is configured to inhibit liquid from leaking out of the beverage cup;
a closure being slidably coupled to said lid, said closure being positionable between an open position and a closed position, said closure covering said drinking aperture when said closure is in said closed position, said drinking aperture being exposed when said closure is in said open position; and
a motion unit being integrated into said lid, said motion unit being in mechanical communication with said closure, said motion unit sensing motion, said motion unit urging said closure into said open position when said motion unit senses that the beverage cup is within a trigger distance of the a user's mouth wherein said motion unit is configured to facilitate the user to drink from the beverage cup without manually opening said closure, said motion unit urging said closure into said closed position when said motion unit no longer senses that the beverage cup is within the trigger distance of the user's mouth, said motion unit comprising:
a control circuit being integrated into said lid, said control circuit receiving an open input and a close input;
an actuator being integrated into said lid, said actuator being in mechanical communication with said closure, said actuator being electrically coupled to said control circuit, said actuator being turned on to urge said closure into said open position when said control circuit receives said open input, said actuator being turned on to urge said closure into said closed position when said control circuit receives said close input;
a motion sensor being coupled to said lid, said motion sensor being electrically coupled to said control circuit, said motion sensor sensing motion within said trigger distance of said lid, said control circuit receiving said open input when said motion sensor senses motion within said trigger distance, said control circuit receiving said close input when said motion sensor does not sense motion within said trigger distance;
a transceiver being integrated into said lid, said transceiver being electrically coupled to said control circuit, said transceiver being in wireless communication with a remote control for remotely controlling said actuator; and
a power supply being removably coupled to said lid, said power supply being electrically coupled to said control circuit, said power supply comprising at least one battery.
